(19) United States
(12) Patent Application Publication
(10) Pub. No.: US 2024/0067068 A1
(43) Pub. Date: Feb. 29, 2024

(54) VEHICLE INTERIOR PANEL AND METHOD OF MANUFACTURE

(71) Applicant: Faurecia Interior Systems, Inc., Auburn Hills, MI (US)

(72) Inventors: Roque VALENZUELA PEREZ, Puebla (MX); Louis THOMAS, Detroit, MI (US)

(21) Appl. No.: 17/896,530

(22) Filed: Aug. 26, 2022

(51) Int. Cl. B60N 2/75; F16B 5/06

(52) U.S. Cl. CPC B60N 2/78; F16B 5/0621

(57) ABSTRACT

A vehicle interior panel having a substrate, a foam layer, and a decorative layer, particularly for a vehicle armrest. The panel includes a foam pad having an inner side, an outer side, and a foam pin located on the outer side. The panel has a substrate having an inner side, an outer side, and an integrated clip. The integrated clip defines an insertion aperture and a flex aperture. The insertion aperture houses the foam pin such that the outer side of the foam pad is held against the inner side of the substrate.

### TECHNICAL FIELD

The invention relates to vehicle interior panels, and more particularly, to vehicle interior panels for armrests and their methods of manufacture.

### BACKGROUND

Vehicle interior panels often include a multi-layer structure, and it can be beneficial to positionally restrain one layer with respect to another. An adhesive layer may be used, but this involves an additional manufacturing step. Integrated clips in a substrate layer can be used, but the clips may not restrain sufficiently with respect to a particular direction, or they may require a corresponding pin or the like that is difficult to manufacture. For example, in DE 202012013179 to Draxlmaier, an undercut must be provided on the pin portion of the assembly to properly mate with and retain the foam layer with respect to the substrate. This undercut at the mating portion requires more complex and expensive foam tooling (e.g., sliders in the tooling may be required to create the undercut). Moreover, the pin design with the undercut can result in more scrap and can increase the risk of quality control issues with respect to the final part.

### SUMMARY

In accordance with an embodiment, there is provided a vehicle interior panel, comprising a foam pad having an inner side, an outer side, and a foam pin located on the outer side. The vehicle interior panel comprises a substrate having an inner side, an outer side, and an integrated clip. The integrated clip defines an insertion aperture and a flex aperture. The insertion aperture houses the foam pin such that the outer side of the foam pad is held against the inner side of the substrate.

In some embodiments, the foam pin is a non-hollow cylindrical member having a non-undercut outer wall and a rounded end.

In some embodiments, the foam pin is a non-hollow cross member.

In some embodiments, the integrated clip comprises a first flex leg and a second flex leg, with the first flex leg and the second flex leg defining two or more outer walls of the flex aperture.

In some embodiments, the first flex leg and the second flex leg are configured to retain the foam pin in a Z-direction and in an X-direction.

In some embodiments, a retention portion connects the first flex leg and the second flex leg.

In some embodiments, the retention portion creates a trapezoidal or curved triangular flex aperture.

In some embodiments, the retention portion has an inward protrusion that increases an area of the insertion aperture.

In some embodiments, the insertion aperture has opposing stabilizing projections.

In some embodiments, the integrated clip has a second flex aperture opposing the first flex aperture with respect to the insertion aperture.

In some embodiments, the integrated clip has a third flex aperture and a fourth flex aperture, with the third flex aperture opposing the fourth flex aperture with respect to the insertion aperture.

In some embodiments, the integrated clip includes two pairs of stabilizing projections, with each stabilizing projection being located at least partially between two adjacent flex apertures.

In some embodiments, an armrest comprises the vehicle interior panel, with the foam pad and the substrate each having a longitudinally extending contour.

In accordance with another embodiment, there is a method of manufacturing a vehicle interior panel comprising the step of inserting a foam pin on an outer side of a foam pad into an integrated clip on a substrate. The integrated clip defines an insertion aperture for housing the foam pin and a flex aperture having one or more flex legs that are configured to bend and retain the foam pin such that the outer side of the foam pad is held against an inner side of the substrate.

In various embodiments, the method includes the step of wrapping the foam pad with a decorative layer and retaining the foam pad in a Z-direction and in an X-direction.

Various aspects, embodiments, examples, features and alternatives set forth in the preceding paragraphs, in the claims, and/or in the following description and drawings may be taken independently or in any combination thereof. For example, features disclosed in connection with one embodiment are applicable to all embodiments in the absence of incompatibility of features.

### DESCRIPTION OF THE DRAWINGS

One or more embodiments will hereinafter be described in conjunction with the appended drawings, wherein like designations denote like elements, and wherein:

FIG. 1 is a perspective view of a portion of the interior of a vehicle passenger cabin with a door armrest;

FIG. 2 is an exploded view of a foam pad and a substrate of the door armrest of FIG. 1;

FIG. 3 is a partial, cross-section view of the assembled foam pad and substrate of FIG. 2, taken along the location corresponding to the line 3-3 in FIG. 2;

FIG. 4 is a partial, bottom view showing the outer side of the substrate of the assembly of FIGS. 2 and 3;

FIG. 5 is an enlarged view of one of the integrated clips shown in FIGS. 2-4;

FIG. 6 is an enlarged view of an integrated clip and foam pin according to another embodiment; and

FIG. 7 is an enlarged view of an integrated clip and foam pin according to another embodiment.

### DETAILED DESCRIPTION OF EMBODIMENTS

Described herein is a vehicle interior panel, particularly one used as a vehicle armrest, as well as related manufacturing methods. The vehicle interior panel includes a foam pad and a substrate. When the foam pad and substrate assembly are subsequently wrapped with a decorative layer, the foam pad and substrate need to be positionally secured to ensure an adequate final product. This securing has been done previously with glue, which requires a separate manufacturing step that can increase the cost of the final panel. This securing has also been attempted by creating an undercut profile on a foam pin to affirmatively lock the foam pin in a through hole on the substrate. However, this arrangement requires a more complex foam tool, and can result in additional scrap and quality concerns on the foam pad layer. The embodiments described herein eliminate the undesirable undercut on the foam pin, and include an integrated clip that can be molded-in the substrate, thereby avoiding an extra assembly step such as gluing. Additionally, the embodiments described herein can be easier to install as compared with the undercut designs.

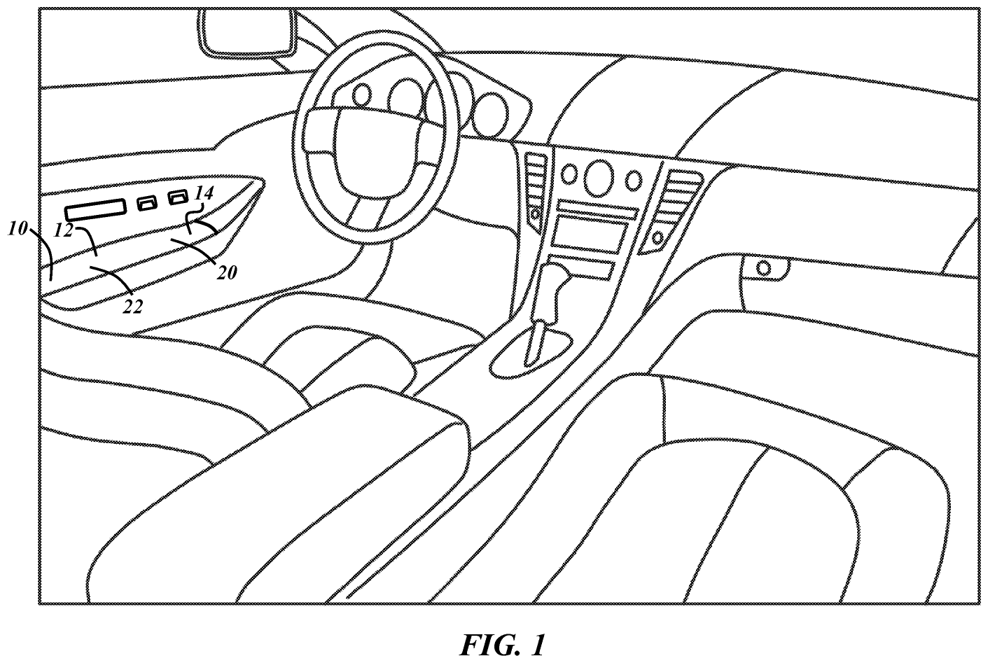

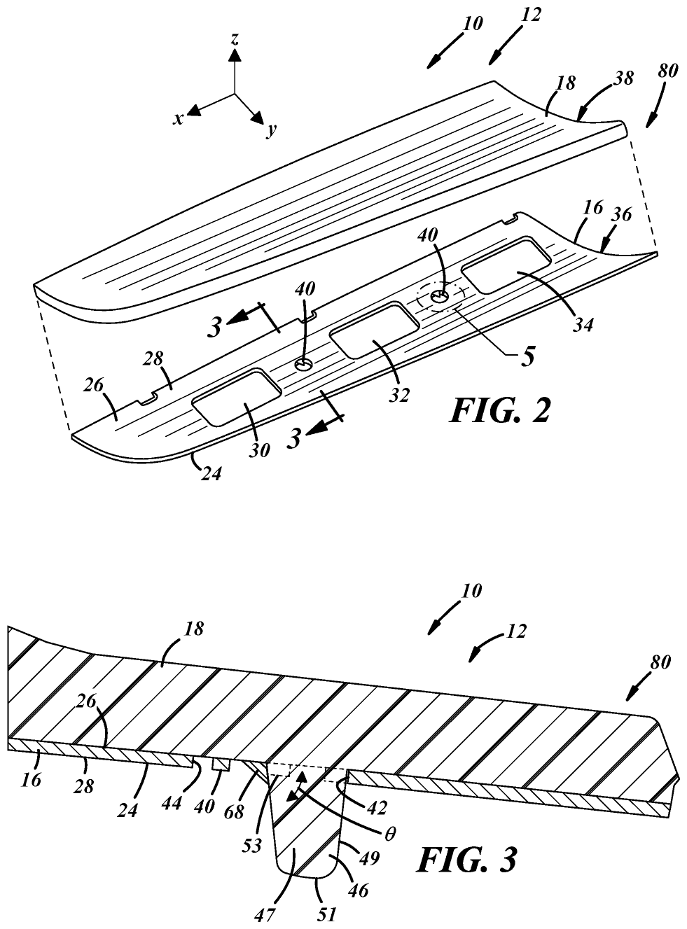

FIGS. 1 and 2 illustrate a vehicle interior panel 10 which in this embodiment, is a door armrest 12. The vehicle panel 10 is a multi-layer assembly having a decorative covering 14 (see FIG. 1), a substrate 16 and a foam pad 18 (see FIG. 2). The panel 10 may be any type of panel having a visible outer side 20 exposed to the interior of a vehicle passenger cabin when installed in the vehicle, such as an instrument panel, console lid, alternately located armrest, etc. Other vehicle panel types and structures are certainly possible, particularly those requiring a positionally secured substrate 16 and foam pad 18.

The decorative covering 14 is the outermost layer of the panel 10 and includes the visible outer side 20 of the panel with an opposite inner side facing toward the substrate 16 and foam pad 18. The decorative covering 14 can have a multi-layer structure, or may just comprise a single skin layer 22. The primary function of the decorative covering 14 and skin layer 22 is to provide a resilient, long-lasting exposed surface within the vehicle with aesthetic appeal to occupants of the passenger cabin, including desirable visual characteristics such as color, shape, and texture. The decorative covering 14 may thus include design features visible at the outer side 20, such as an embossed pattern or a paint film in the desired color. The decorative covering 14 may also at least partly provide the panel 10 with desired tactile characteristics in the likeness of furniture upholstery, such as a soft-touch or smooth feel. In some cases, the decorative covering 14 is formed with synthetic materials configured with aesthetic characteristics imitating other more expensive materials such as leather. In other implementations, the decorative covering 14 and/or skin layer 22 is a natural material such as leather. Other materials for the decorative covering 14 and/or skin layer 22 are certainly possible. Further, other interlayers or components may be included at or near the skin layer 22, depending on the desired implementation.

The substrate 16 is typically the most rigid of the illustrated panel layers and thereby provides structural support for the overlying layers at desired locations within the vehicle via attachment to other vehicle structures. Polyethylene (PE) plastic having a thickness of 1 mm to 5 mm is one example of a suitable substrate 16, but various other types of materials and material combinations and/or different thickness ranges can be employed in a similar manner. The substrate 16 includes an outer side 24 that faces away from the vehicle interior cabin, and an opposite inner side 26 that faces toward the vehicle interior cabin.

The substrate 16 for the door armrest 12 is a trampoline 28 that has a plurality of flexion through holes 30, 32, 34. This allows the more rigid material of the substrate 16 to flex, which can be more beneficial in an armrest 12 implementation, as it can provide additional give and comfort to the user. Additionally, the substrate 16, as well as the foam pad 18, each have a longitudinally extending contour 36, 38. The longitudinally extending contours 36, 38 are also particularly advantageous in the armrest 12 implementation, as they more closely match the outer contour of a user's arm. The longitudinally extending contours 36, 38 extend along the longest length of the panel 10.

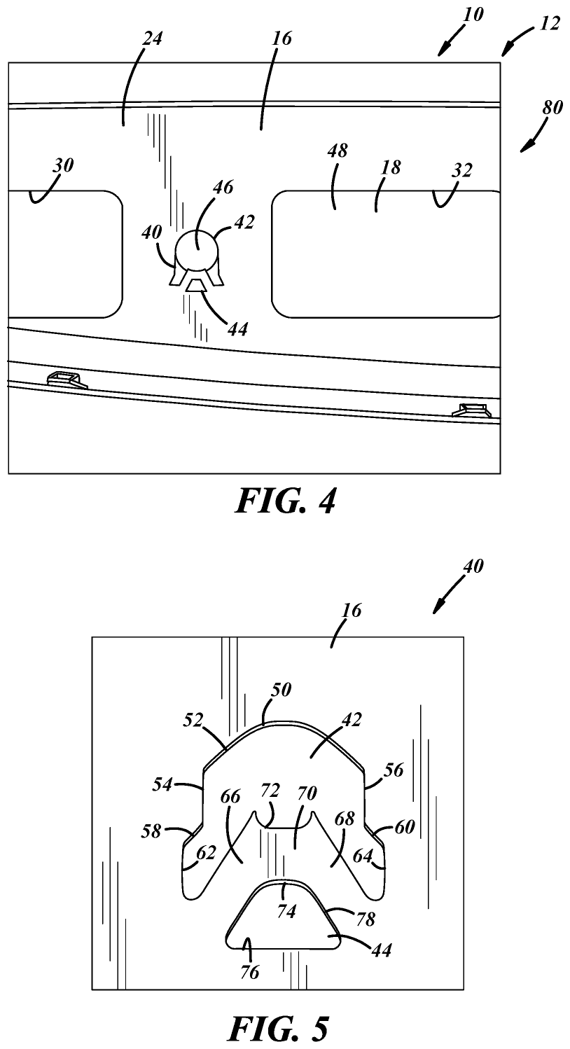

With particular reference to FIGS. 3-5, the substrate 16 includes one or more integrated clips 40. The integrated clips 40, as well as the flexion through holes 30, 32, 34, are advantageously injection molded into the substrate 16 when the substrate is initially formed, which can help streamline post-processing efforts. This embodiment has two integrated clips 40 given the length of the panel 10, but more or less clips may be included than what is particularly illustrated. The integrated clip 40 defines an insertion aperture 42 and a flex aperture 44, each of which being a through hole that extends entirely between the outer side 24 and the inner side 26 of the substrate 16. The insertion aperture 42 houses a foam pin 46 located on the foam pad 18 such that an outer side 48 of the foam pad 18 is held against the inner side 26 of the substrate 16. In the presently disclosed embodiments, the insertion aperture 42 and the flex aperture 44 of the integrated clip 40 are located directly adjacent each other, and are spaced quite closely (e.g., less than 10 mm, and more preferably between 0.25 mm and 2 mm from each other). This spacing and structural arrangement of the integrated clip 40 can improve the flexion of the clip to better retain the foam pin 46, compared to, for example, tabs or the like that do not have a flex aperture 44.

As shown in FIG. 5, the insertion aperture 42 has an outer wall 50 that includes a semi-circular segment 52 connected to two opposing straight segments 54, 56. The opposing straight segments 54, 56 are connected to two angular transition segments 58, 60, which lead to flex leg accommodation segments 62, 64. The remaining outer wall 50 of the insertion aperture 42 is defined by two respective flex legs 66, 68 and a retention portion 70 that connects the first flex leg 66 and the second flex leg 68. The retention portion 70 includes an inward protrusion 72, which in this embodiment has a semi-circular shape to better accommodate the cylindrical foam pin 46. The inward protrusion 72 increases the area of the insertion aperture 42, which can allow for easier installation of the foam pin 46 into the insertion aperture 42. Furthermore, the flex leg accommodation segments 62, 64 also provide increased area for movement of the flex legs 66, 68.

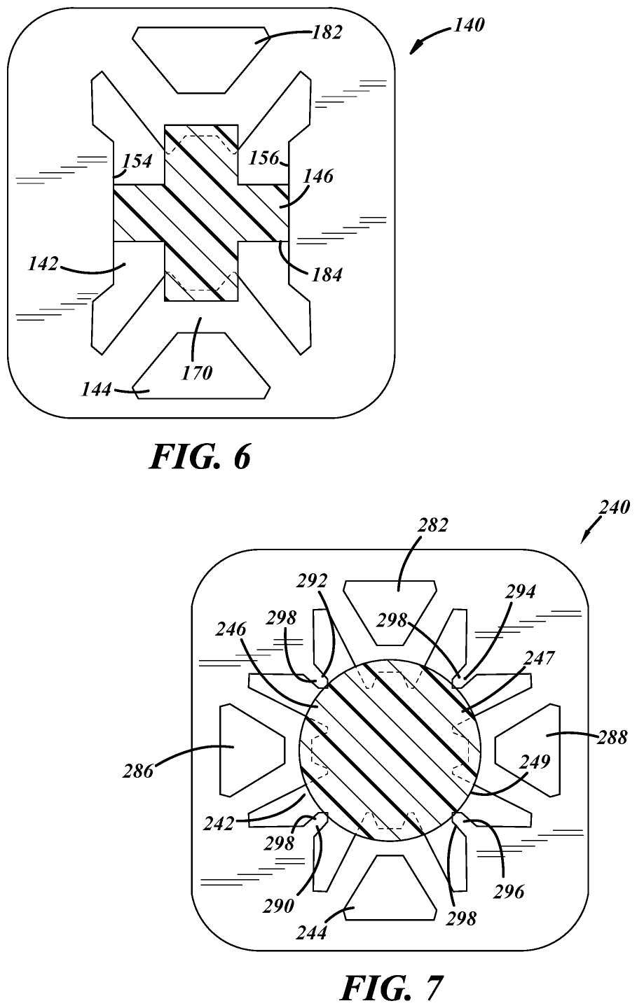

The flex aperture 44 also has an outer wall 74 that is at least partially defined by the two respective flex legs 66, 68. In this embodiment, the flex legs 66, 68 are oriented at about a 45° angle with respect to each other, and accordingly, a flex leg transition segment 76 is needed to complete the outer wall 74 of the flex aperture 44. As shown in FIG. 5, the flex aperture 44 is a curved triangular flex aperture 78, which can be formed by a shorter retention portion 70. In other embodiments, such as that illustrated in FIG. 6, the retention portion 170 is longer, thus leading to a trapezoidal flex aperture 144 (like reference numerals denote like components). The length of the retention portion 70 can be chosen depending on the shape and size of the foam pin 46 to enhance manufacturability and retention performance.

Returning to FIG. 3, when the foam pin 46 is inserted into the insertion aperture 42, the flex legs 66, 68 bend to provide a friction fit and retention of the foam pad 18 with respect to the substrate (only one flex leg 68 is shown in the cross-section view of FIG. 3). As compared to standard tabs or the like, the flex aperture 44 allows for improved flexibility of each of the flex legs 66, 68 which can make the foam pad 18 and substrate 16 assembly 80 easier for an operator to put together, thereby decreasing manufacturing time. The flex legs 66, 68 are configured to bend at an angle θ of about 10° to help retain the foam pin 46 in the Z-direction. Additionally, since the flex legs 66, 68 are oriented only on one side of the insertion aperture 42, there is provided at least some retention as well in the X-direction, given the size and shape of the insertion aperture. This may be sufficient to retain the foam pad 18 with respect to the substrate 16 during the subsequent wrapping operation and can be easier to injection mold, but as described further below, more flex legs may be included in the integrated clip 40 to improve retention in other directions.

FIGS. 6 and 7 illustrate alternate embodiments of the integrated clip 140, 240 (again, with like reference numerals denoting like components and some reference numerals being omitted for clarity purposes). These embodiments may be more complex to injection mold than the embodiment illustrated in FIG. 5, but they can facilitate easier installation of the assemblies. In FIG. 6, there is a second flex aperture 182 that opposes the first flex aperture 144 with respect to the insertion aperture 142. Since the second flex aperture 182 takes the place of the semi-circular segment 52 in the embodiment of FIG. 5, the insertion aperture 142 is generally defined by each retention portion between each pair of flex legs and the two straight segments 154, 156. Given this shape, the foam pin 146 is a solid cross member 184 having a cross-shape to more securely fit within the insertion aperture 142.

In FIG. 7, there is a third flex aperture 286 and a fourth flex aperture 288, with the third flex aperture opposing the fourth flex aperture with respect to the insertion aperture 242. Also included in this embodiment are two opposing pairs of stabilizing projections 290, 292, 294, 296. The first stabilizing projection 290 is located between the first flex aperture 244 and the third flex aperture 286. The second stabilizing projection 292 is located between the second flex aperture 282 and the third flex aperture 286. The third stabilizing projection 294 is located between the second flex aperture 282 and the fourth flex aperture 288. The fourth stabilizing projection 296 is located between the first flex aperture 244 and the fourth flex aperture 288. The stabilizing projections 290, 292, 294, 296 are each structured with a width reduced portion 298 closer to the foam pin 246, which can provide more space for each flex leg within the insertion portion 242.

Returning to FIG. 3, the foam pad 18 can assist the ultimately applied decorative covering 14 in providing desired tactile characteristics to the panel 10 in the form of cushioning that compresses when a force is applied to the skin outer side 20 of the panel 10 and decompresses when the force is removed to return the skin layer to its original position. The foam pad 18 may also include other layers, such as fabric or scrim layers, adhesive layers, etc., but advantageously, the foam pad 18 does not include an adhesive layer between the outer side 48 of the foam pad and then inner side 26 of the substrate 16. The foam pad 18 can also provide sound deadening and/or have a non-uniform thickness to fill space between the decorative covering 14 and the substrate 16 when the respective contours of the decorative covering and substrate are different from each other. In the illustrated examples, the foam pad 18 is a preformed component manufactured in a foam molding tool which is then installed on the substrate 16 before being wrapped with the decorative covering 14. One suitable foam material is polyurethane foam, but other foam materials (e.g., polyolefin-based) are possible, as are other foam manufacturing processes. The foam pad 18 may range in thickness from 1 mm to 10 mm, and is integrally formed with one or more foam pins 46 on the outer side 48 to interlock with the integrated clips 40.

The foam pin 46 is a non-hollow cylindrical member 47 having a tapered, non-undercut outer wall 49 that extends between the outer side 48 of the foam pad 18 and an end portion 51 of the foam pin. The tapered shape and the rounded configuration for the end portion 51 can be easier to manufacture, given the draft angles. Additionally, having a solid or non-hollow pin 46 can also be easier to manufacture than hollow pins or the like. For illustration purposes, an undercut 53 is shown in dotted lines adjacent the substrate 16 at the outer side 48 of the foam pad 18, which is a diametrically reduced portion as compared to the portion of the foam pin 46 that extends beyond the outer side 24 of the substrate 16. The embodiments of the present disclosure advantageously do not necessarily employ this undercut 53, as it can be difficult and more costly to manufacture.

It is to be understood that the foregoing is a description of one or more preferred example embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A vehicle interior panel, comprising:
a foam pad having an inner side, an outer side, and a foam pin located on the outer side; and
a substrate having an inner side, an outer side, and an integrated clip, wherein the integrated clip defines an insertion aperture and a flex aperture, the insertion aperture housing the foam pin such that the outer side of the foam pad is held against the inner side of the substrate.

2. The vehicle interior panel of claim 1, wherein the foam pin is a non-hollow cylindrical member having a non-undercut outer wall and a rounded end.

3. The vehicle interior panel of claim 1, wherein the foam pin is a non-hollow cross member.

4. The vehicle interior panel of claim 1, wherein the integrated clip comprises a first flex leg and a second flex leg, with the first flex leg and the second flex leg defining two or more outer walls of the flex aperture.

5. The vehicle interior panel of claim 4, wherein the first flex leg and the second flex leg are configured to retain the foam pin in a Z-direction and in an X-direction.

6. The vehicle interior panel of claim 4, comprising a retention portion connecting the first flex leg and the second flex leg.

7. The vehicle interior panel of claim 6, wherein the retention portion creates a trapezoidal or curved triangular flex aperture.

8. The vehicle interior panel of claim 6, wherein the retention portion has an inward protrusion that increases an area of the insertion aperture.

9. The vehicle interior panel of claim 1, wherein the insertion aperture has opposing stabilizing projections.

10. The vehicle interior panel of claim 1, wherein the integrated clip has a second flex aperture opposing the first flex aperture with respect to the insertion aperture.

11. The vehicle interior panel of claim 1, wherein the integrated clip has a third flex aperture and a fourth flex aperture, with the third flex aperture opposing the fourth flex aperture with respect to the insertion aperture.

12. The vehicle interior panel of claim 11, wherein the integrated clip includes two pairs of stabilizing projections, with each stabilizing projection being located at least partially between two adjacent flex apertures.

13. An armrest comprising the vehicle interior panel of claim 1, wherein the foam pad and the substrate each have a longitudinally extending contour.

14. A method of manufacturing a vehicle interior panel, comprising the step of:
inserting a foam pin on an outer side of a foam pad into an integrated clip on a substrate, wherein the integrated clip defines an insertion aperture for housing the foam pin and a flex aperture having one or more flex legs that are configured to bend and retain the foam pin such that the outer side of the foam pad is held against an inner side of the substrate.

15. The method of claim 14, further comprising the step of wrapping the foam pad with a decorative layer and retaining the foam pad in a Z-direction and in an X-direction.
